(19) United States
(12) Patent Application Publication
(10) Pub. No.: US 2026/0095882 A1
(43) Pub. Date: Apr. 2, 2026

(54) SCHEDULING FOR WI-FI-BASED POSITIONING AND HYBRIDIZATION WITH CELLULAR-BASED POSITIONING

(71) Applicant: QUALCOMM Incorporated, San Diego, CA (US)

(72) Inventors: Varun Amar REDDY, San Diego, CA (US); Alexandros MANOLAKOS, Athens (GR); Krishna Kiran MUKKAVILLI, San Diego, CA (US)

(21) Appl. No.: 19/112,118

(22) PCT Filed: Oct. 11, 2023
(86) PCT No.: PCT/US2023/076600

§ 371 Date: Mar. 14, 2025

(30) Foreign Application Priority Data
Nov. 23, 2022 (GR) 20220100962

(51) Int. Cl. H04W 64/00; H04W 52/32

(52) U.S. Cl. CPC H04W 64/00; H04W 52/325

(57) ABSTRACT

Disclosed are techniques for wireless positioning. In an aspect, an access point controller receives, from one or more wireless communications devices, one or more sets of parameters related to positioning capabilities of the one or more wireless communications devices, assigns priorities to the one or more wireless communications devices based on the one or more sets of parameters, identifies at least one group of wireless communications devices of the one or more wireless communications devices that is associated with at least one common access point of one or more access points in communication with the access point controller, and schedules a positioning session for each wireless communications device in the at least one group of wireless communications devices with the at least one common access point.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless positioning performed by an access point controller includes receiving, from one or more wireless communications devices, one or more sets of parameters related to positioning capabilities of the one or more wireless communications devices; assigning priorities to the one or more wireless communications devices based on the one or more sets of parameters; identifying at least one group of wireless communications devices of the one or more wireless communications devices that is associated with at least one common access point of one or more access points in communication with the access point controller; and scheduling a positioning session for each wireless communications device in the at least one group of wireless communications devices with the at least one common access point.

In an aspect, a method of wireless positioning performed by a server includes receiving a first configuration response from an access point controller, the first configuration response including a first set of parameters related to positioning one or more wireless communications devices using one or more access points; receiving a second configuration response from a location server, the second configuration response including a second set of parameters related to positioning the one or more wireless communications devices using one or more transmission-reception points (TRPs); transmitting an allocation report to the access point controller, the allocation report providing assistance information for scheduling a first set of positioning sessions for the one or more wireless communications devices with the one or more access points; and transmitting session scheduling information to the one or more wireless communications devices, the session scheduling information configuring the one or more wireless communications devices for a second set of positioning sessions with the one or more TRPs.

In an aspect, an access point controller includes a memory; at least one transceiver; and at least one processor communicatively coupled to the memory and the at least one transceiver, the at least one processor configured to: receive, via the at least one transceiver, from one or more wireless communications devices, one or more sets of parameters related to positioning capabilities of the one or more wireless communications devices; assign priorities to the one or more wireless communications devices based on the one or more sets of parameters; identify at least one group of wireless communications devices of the one or more wireless communications devices that is associated with at least one common access point of one or more access points in communication with the access point controller; and schedule a positioning session for each wireless communications device in the at least one group of wireless communications devices with the at least one common access point.

In an aspect, a server includes a memory; at least one transceiver; and at least one processor communicatively coupled to the memory and the at least one transceiver, the at least one processor configured to: receive, via the at least one transceiver, a first configuration response from an access point controller, the first configuration response including a first set of parameters related to positioning one or more wireless communications devices using one or more access points; receive, via the at least one transceiver, a second configuration response from a location server, the second configuration response including a second set of parameters related to positioning the one or more wireless communications devices using one or more transmission-reception points (TRPs); transmit, via the at least one transceiver, an allocation report to the access point controller, the allocation report providing assistance information for scheduling a first set of positioning sessions for the one or more wireless communications devices with the one or more access points; and transmit, via the at least one transceiver, session scheduling information to the one or more wireless communications devices, the session scheduling information configuring the one or more wireless communications devices for a second set of positioning sessions with the one or more TRPs.

In an aspect, an access point controller includes means for receiving, from one or more wireless communications devices, one or more sets of parameters related to positioning capabilities of the one or more wireless communications devices; means for assigning priorities to the one or more wireless communications devices based on the one or more sets of parameters; means for identifying at least one group of wireless communications devices of the one or more wireless communications devices that is associated with at least one common access point of one or more access points in communication with the access point controller, and means for scheduling a positioning session for each wireless communications device in the at least one group of wireless communications devices with the at least one common access point.

In an aspect, a server includes means for receiving a first configuration response from an access point controller, the first configuration response including a first set of parameters related to positioning one or more wireless communications devices using one or more access points; means for receiving a second configuration response from a location server, the second configuration response including a second set of parameters related to positioning the one or more wireless communications devices using one or more transmission-reception points (TRPs); means for transmitting an allocation report to the access point controller, the allocation report providing assistance information for scheduling a first set of positioning sessions for the one or more wireless communications devices with the one or more access points; and means for transmitting session scheduling information to the one or more wireless communications devices, the session scheduling information configuring the one or more wireless communications devices for a second set of positioning sessions with the one or more TRPs.

In an aspect, a non-transitory computer-readable medium stores computer-executable instructions that, when executed by an access point controller, cause the access point controller to: receive, from one or more wireless communications devices, one or more sets of parameters related to positioning capabilities of the one or more wireless communications devices; assign priorities to the one or more wireless communications devices based on the one or more sets of parameters; identify at least one group of wireless communications devices of the one or more wireless communications devices that is associated with at least one common access point of one or more access points in communication with the access point controller; and schedule a positioning session for each wireless communications device in the at least one group of wireless communications devices with the at least one common access point.

In an aspect, a non-transitory computer-readable medium stores computer-executable instructions that, when executed by a server, cause the server to: receive a first configuration response from an access point controller, the first configuration response including a first set of parameters related to positioning one or more wireless communications devices using one or more access points; receive a second configuration response from a location server, the second configuration response including a second set of parameters related to positioning the one or more wireless communications devices using one or more transmission-reception points (TRPs); transmit an allocation report to the access point controller, the allocation report providing assistance information for scheduling a first set of positioning sessions for the one or more wireless communications devices with the one or more access points; and transmit session scheduling information to the one or more wireless communications devices, the session scheduling information configuring the one or more wireless communications devices for a second set of positioning sessions with the one or more TRPs.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates examples of various positioning methods supported in New Radio (NR), according to aspects of the disclosure.

FIG. 5 is a timing diagram of an example measurement sounding phase of a non-trigger-based (non-TB) ranging procedure as defined in the Institute of Electrical and Electronics Engineers (IEEE) 802.11az standard.

FIG. 6 is a diagram illustrating an example non-TB ranging measurement exchange sequence as defined in the IEEE 802.11 az standard.

FIG. 7 is a timing diagram of an example measurement sounding phase of a trigger-based (TB) ranging procedure as defined in the IEEE 802.11 az standard.

FIG. 8 is a diagram illustrating an example TB ranging measurement exchange sequence as defined in the IEEE 802.11az standard.

FIG. 9 is a diagram 900 illustrating an example TB ranging measurement exchange sequence using spatial multiplexing as defined in the IEEE 802.11 az standard.

FIG. 10 is a diagram illustrating an example grid of Wi-Fi access points (APs) that may deployed in an industrial retail store or warehouse, according to aspects of the disclosure.

FIG. 11 is a call flow illustrating an example of server-assisted scheduling without New Radio (NR) hybridization, according to aspects of the disclosure.

FIG. 12 is a call flow illustrating an example of server-assisted scheduling with NR hybridization, according to aspects of the disclosure.

FIGS. 13 and 14 illustrate example methods of wireless positioning, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to”perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions, A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs),

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal”refers to a wireless signal or an RF signal.

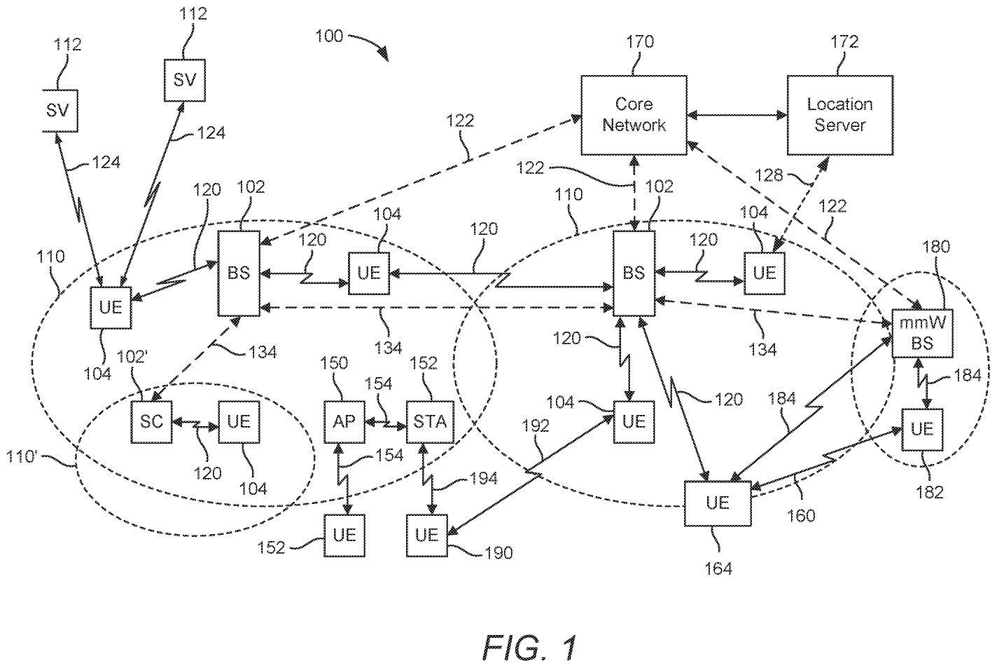

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGD), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage arca 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz), When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mm W/near mmW radio frequency band have high path loss and a relatively short range. The mm W base station 180 and the UE 182 may utilize beamforming (transmit and/or receive) over a mm W communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station, The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz), It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave”band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz.” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,”and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mm W base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

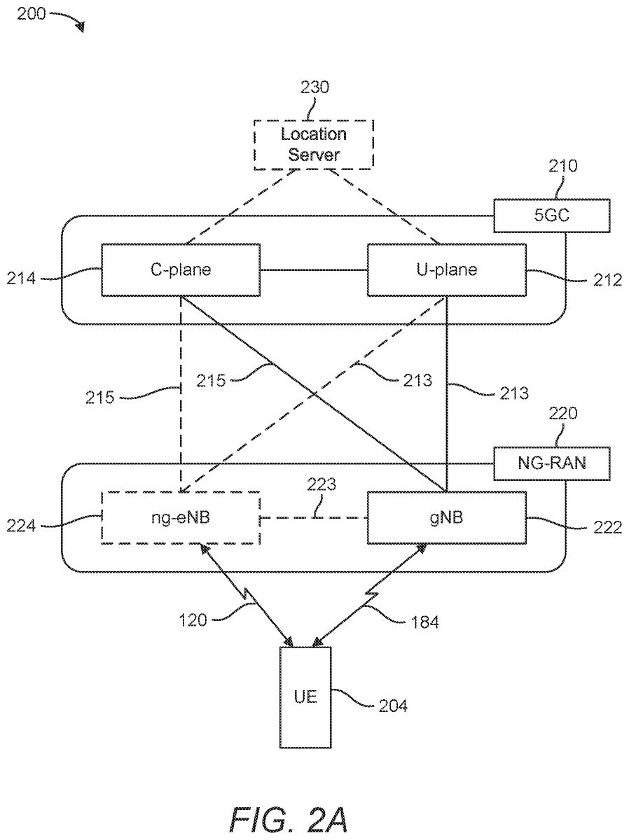

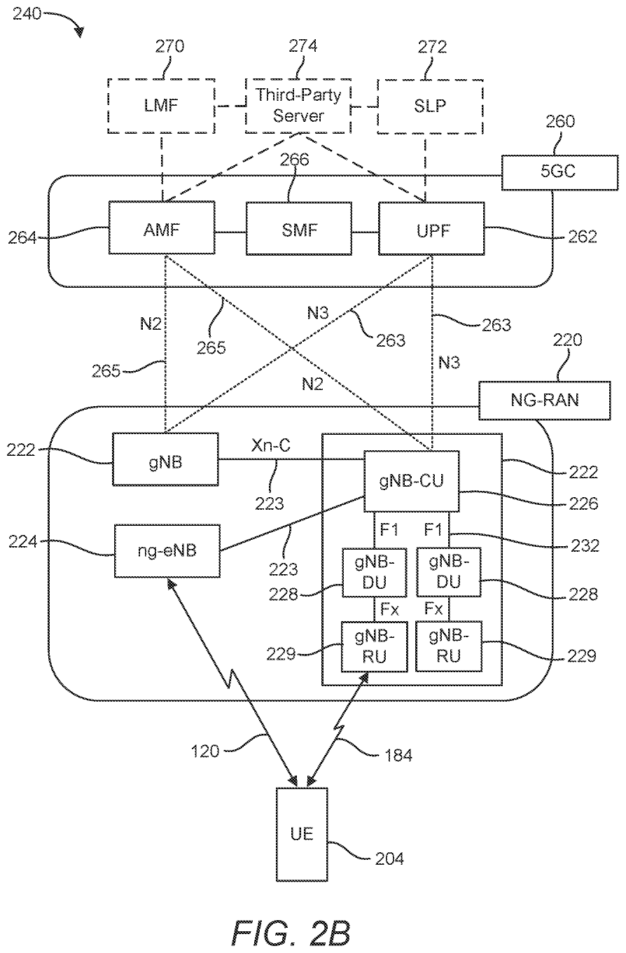

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu”interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

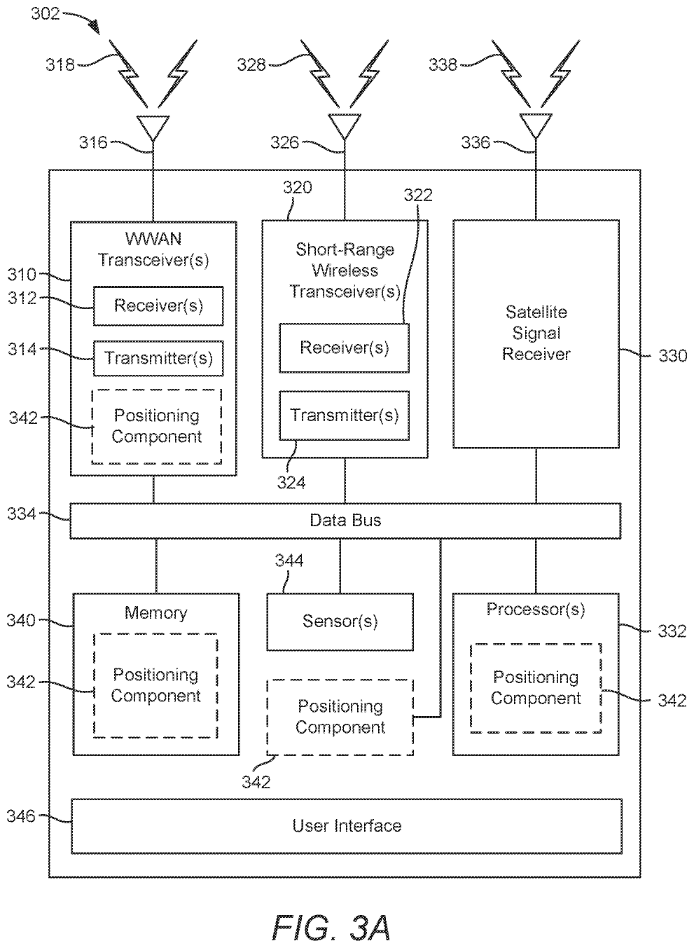

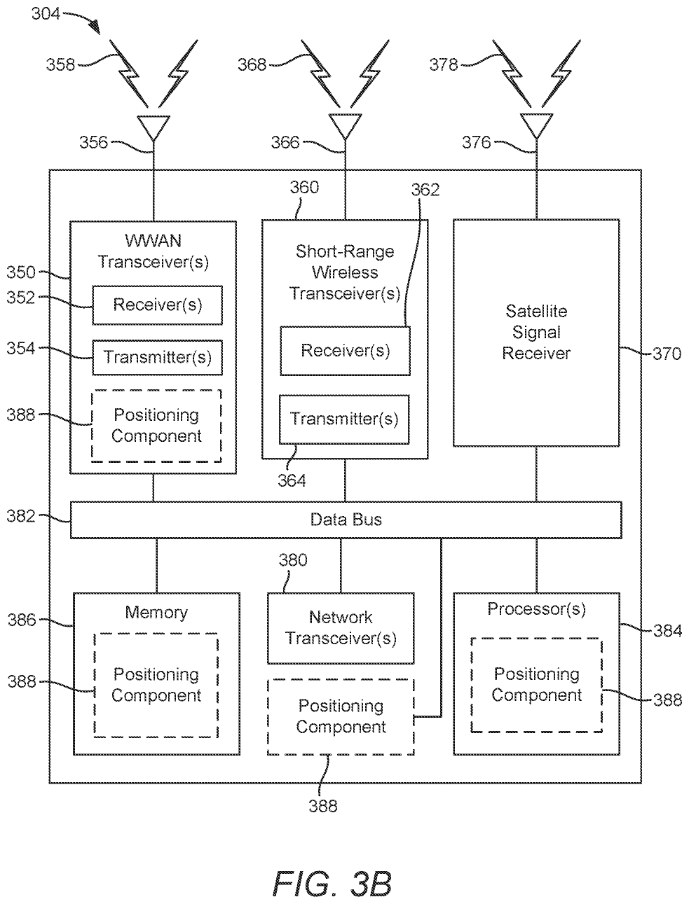

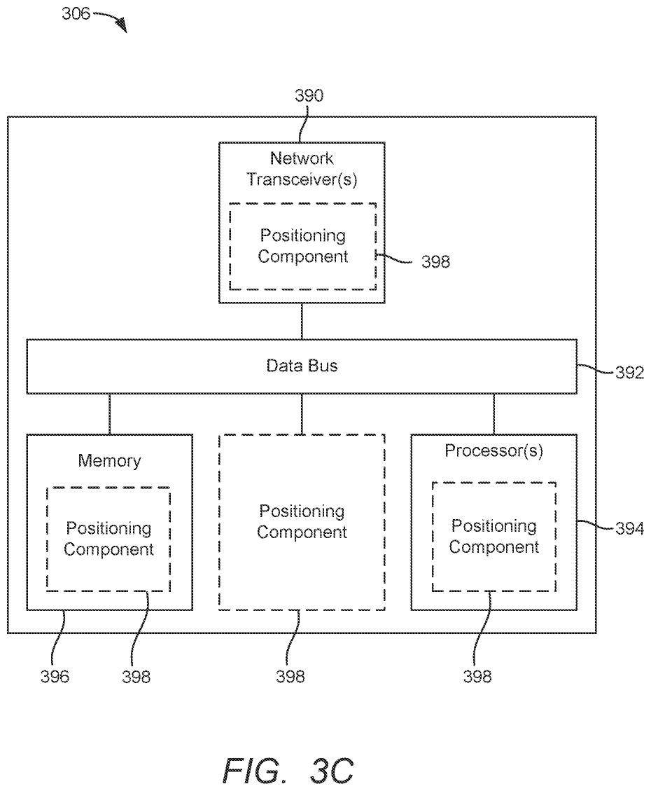

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein, It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (LI) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-I functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the downlink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

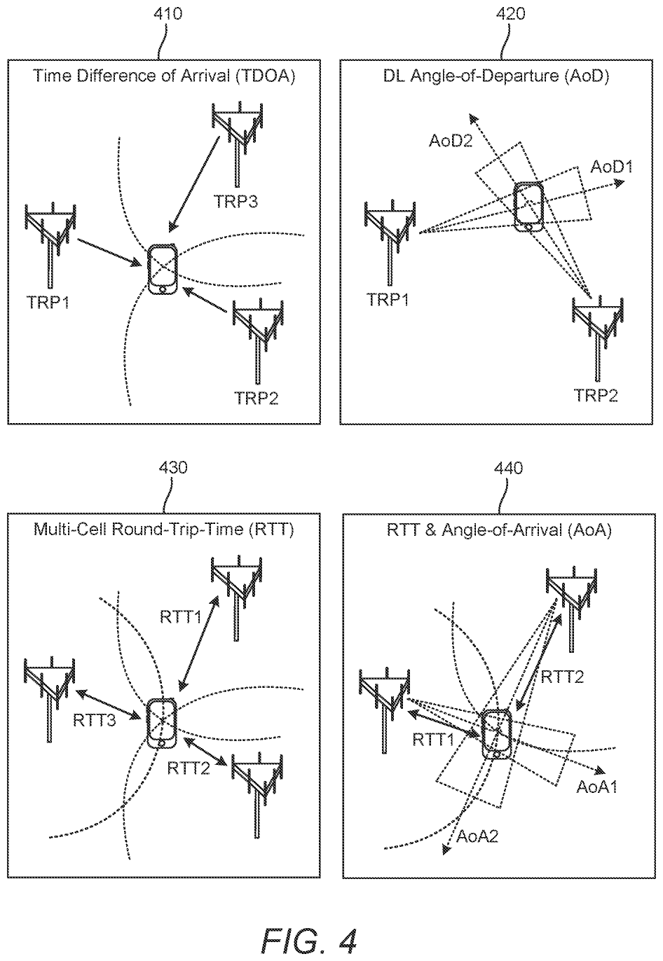

NR supports a number of cellular network-based positioning technologies, including downlink-based, uplink-based, and downlink-and-uplink-based positioning methods, Downlink-based positioning methods include observed time difference of arrival (OTDOA) in LTE, downlink time difference of arrival (DL-TDOA) in NR, and downlink angle-of-departure (DL-AoD) in NR. FIG. 4 illustrates examples of various positioning methods, according to aspects of the disclosure. In an OTDOA or DL-TDOA positioning procedure, illustrated by scenario 410, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 420, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of cach non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 430, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 440.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 us.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

The various Wi-Fi standards also support various Wi-Fi-based positioning techniques. For example, IEEE 802.11az standard (which is based on the IEEE 802.11 ax standard) introduces enhancements for Wi-Fi-based ranging. A Wi-Fi-based ranging procedure is a type of RTT procedure, and is based on the transmit and receive times of null data packet (NDP) frames at an initiating STA (ISTA) and a responding STA (RSTA). In a Wi-Fi-based ranging procedure. the ISTA is typically a UE, such as a user device, asset tag, or the like, and the RSTA is typically a Wi-Fi AP. An NDP frame is a ranging frame, and comprises the preamble along with some PHY headers-it does not include a payload. An NDP transmitted by the RSTA to an ISTA is denoted as an “R2I NDP” and an NDP transmitted by an ISTA to an RSTA is denoted as an “I2R NDP.”

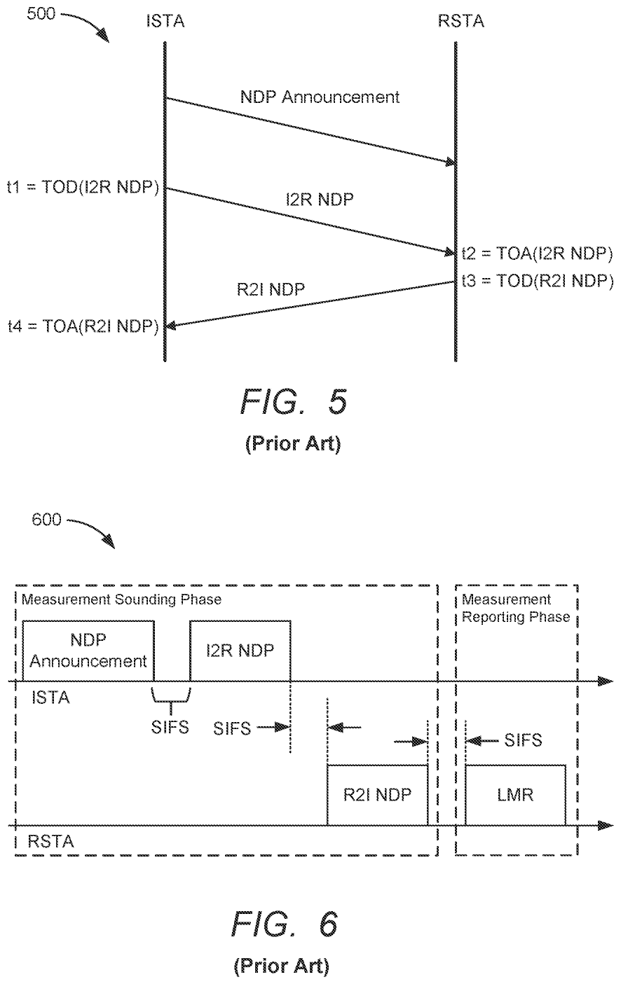

FIG. 5 is a timing diagram 500 of an example measurement sounding phase of a non-trigger-based (non-TB) ranging procedure as defined in the IEEE 802.11az. FIG. 6 is a diagram 600 illustrating an example non-TB ranging measurement exchange sequence as defined in IEEE 802.11az. In a non-TB ranging procedure, the RSTA broadcasts a beacon (not shown) to inform ISTAs which channel(s) are available for non-TB ranging. An ISTA then initiates the ranging session on one of the channels using carrier sense multiple access with collision avoidance (CSMA/CA). As shown in FIGS. 5 and 6, an ISTA initiates the ranging session by transmitting an NDP announcement to notify the RSTA that it will be transmitting an I2R NDP for which the RSTA should monitor. After the NDP announcement frame is transmitted successfully, the involved STAs can retain the channel since the gap between the subsequent packets is no longer than the shortest interframe spacing (SIFS) defined for Wi-Fi communication, as shown in FIG. 6.

During the measurement sounding phase, each STA transmits an NDP frame to the other STA, as illustrated in FIGS. 5 and 6. The ISTA measures the transmission time, or time-of-departure (ToD), of the I2R NDP transmitted to the ISTA (denoted “t1”) and the reception time, or time-of-arrival (ToA), of the R2I NDP received from the ISTA (denoted “t4”). The RSTA measures the reception time/ToA of the I2R NDP received from the ISTA (denoted “t2”) and the transmission time/ToD of the R2I NDP transmitted to the ISTA (denoted “t3”).

After the measurement sounding phase, the RSTA transmits a location measurement report (LMR) to the ISTA during a measurement reporting phase, as illustrated in FIG. 6. The LMR includes the reception time/ToA of the I2R NDP (“t2”) and the transmission time/ToD of the R2I NDP (“t3”). If available, the RSTA may also include the angle of arrival (AoA) of the I2R NDP and/or the angle-of-departure (AoD) of the R2I NDP. The LMR may also include the geographic location of the RSTA, if known. Based on the timing measurements from the RSTA and its own timing measurements (“t1” and “t4”), the ISTA can determine the time-of-flight (ToF) between itself and the RSTA, and therefore the range/distance between itself and the RSTA.

An ISTA may perform a ranging procedure with one or more RSTAs. For RSTAs having zero or inaccurate knowledge of their location, the ranging procedure yields an inter-STA range (distance) between the involved STAs. For RSTAs having accurate knowledge of their location, the range can yield an absolute position if at least three involved RSTAs have known locations, or angle-based information (e.g., AoA/AoD) for at least one RSTA is available (note that the ISTA may also be able to determine AoA and/or AoD measurements that can further be used to enhance the position estimate).

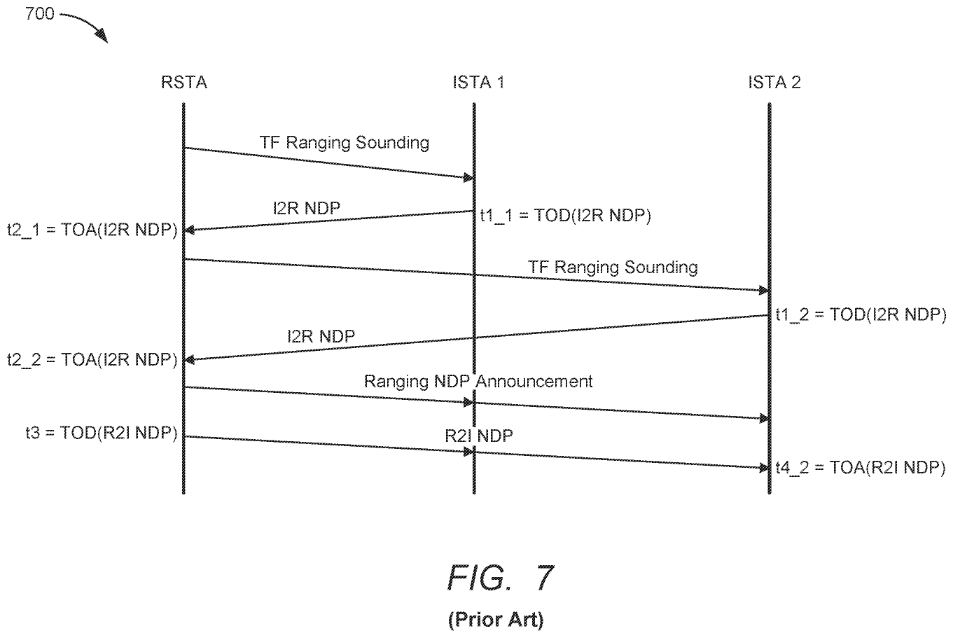

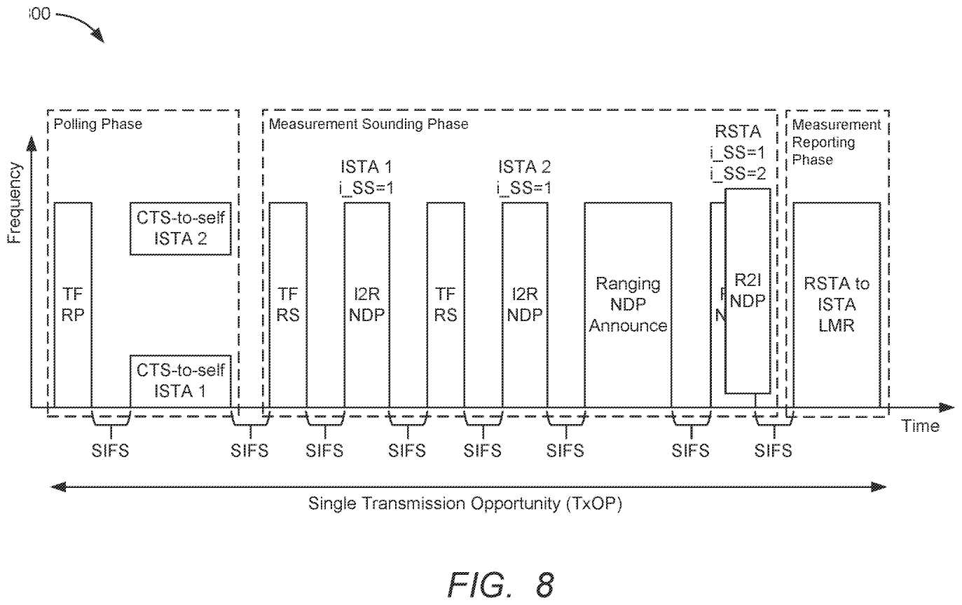

FIG. 7 is a timing diagram 700 of an example measurement sounding phase of a trigger-based (TB) ranging procedure as defined in the IEEE 802.11az. FIG. 8 is a diagram 800 illustrating an example TB ranging measurement exchange sequence as defined in IEEE 802.11az. An RSTA triggers ranging message transmissions from each of the ISTAs that are taking part in the ranging session (denoted “ISTA 1” and “ISTA 2” in FIGS. 7 and 8) by broadcasting a trigger frame (TF) ranging poll (denoted “TF RP” in FIG. 8). ISTAs join the session by transmitting an acknowledgment (ACK) during the polling phase (illustrated as a clear-to-send (CTS)-to-self message).

During the measurement sounding phase, the RSTA transmits a TF ranging sounding (denoted “TF RS” in FIG. 8) to each participating ISTA. In response, each ISTA transmits an I2R NDP frame. Each ISTA transmits the I2R NDP on the same spatial stream (SS) (denoted “i_SS=1” in FIG. 8). The RSTA then broadcasts its own R2I NDP frame to the involved ISTAs on different spatial streams (denoted “i_SS=1” and “i_SS=2” in FIG. 8). For two ISTAs, this approach has lower overhead/latency than the non-TB-based approach, but that reduction is only achieved if the ISTAs are scheduled jointly.

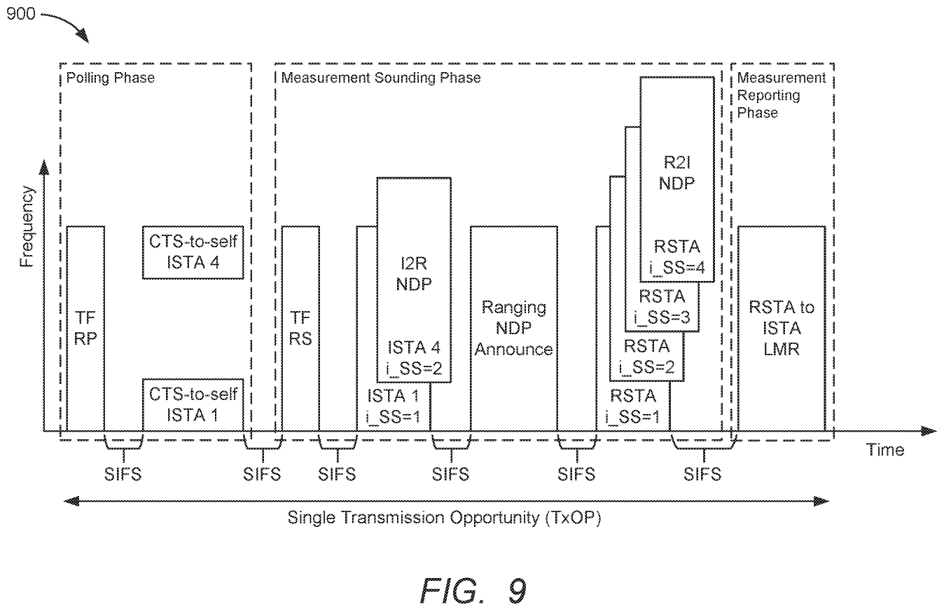

FIG. 9 is a diagram 900 illustrating an example TB ranging measurement exchange sequence using spatial multiplexing as defined in IEEE 802.11az. The polling phase in FIG. 9 is the same as the polling phase in FIG. 8. Likewise, the measurement reporting phase in FIG. 9 is the same as in FIG. 8.

Multi-user positioning can be achieved through multi-user multiple-input multiple-output (MU-MIMO) techniques on both the downlink (e.g., from the RSTA to the ISTA) and the uplink (e.g., from the ISTA to the RSTA). During the measurement sounding phase, a TF ranging sounding (denoted “TF RS” in FIG. 9) allocates uplink resources for one or more ISTAs so that their I2R NDP frames are multiplexed in the spatial stream (SS) domain, optionally spanning the full bandwidth of the RSTA. Thus, as shown in FIG. 9, the two example ISTAs (denoted “ISTA 1” and “ISTA 4”) each transmit an I2R NDP on different spatial streams (denoted “i_SS=1” and “i_SS=2”), The two ISTAs transmit these I2R NDPs simultaneously, but on multiplexed resources so that they do not interfere with each other. In response, the RSTA transmits one R2I NDP on four spatial streams (denoted “i_SS=1”to “i_SS=4”).

Note that while FIGS. 7 and 8 illustrate two ISTAs, as will be appreciated, there may be more or fewer than two involved/participating ISTAs. Similarly, while FIG. 9 illustrates the RSTA transmitting an R2I NDP on four spatial streams, as will be appreciated, the R2I may be transmitted on more or fewer than four spatial streams.

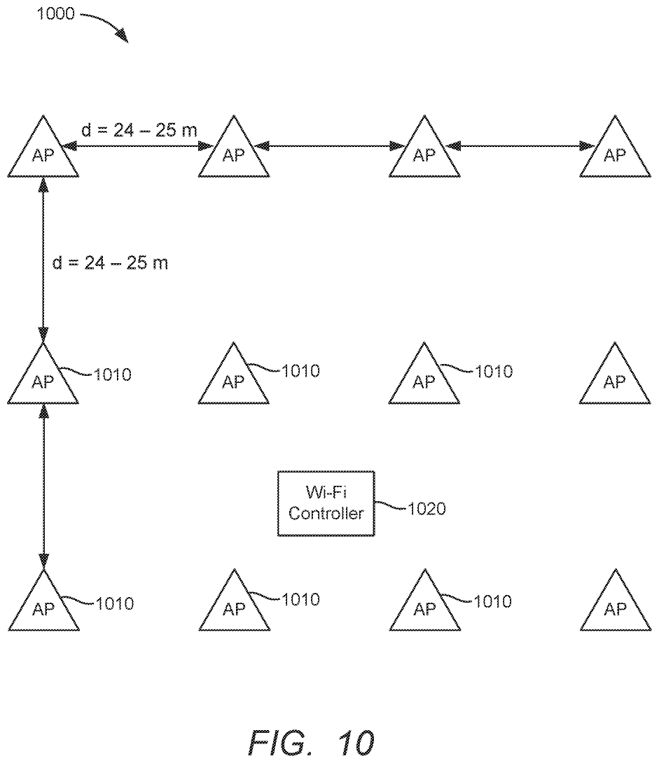

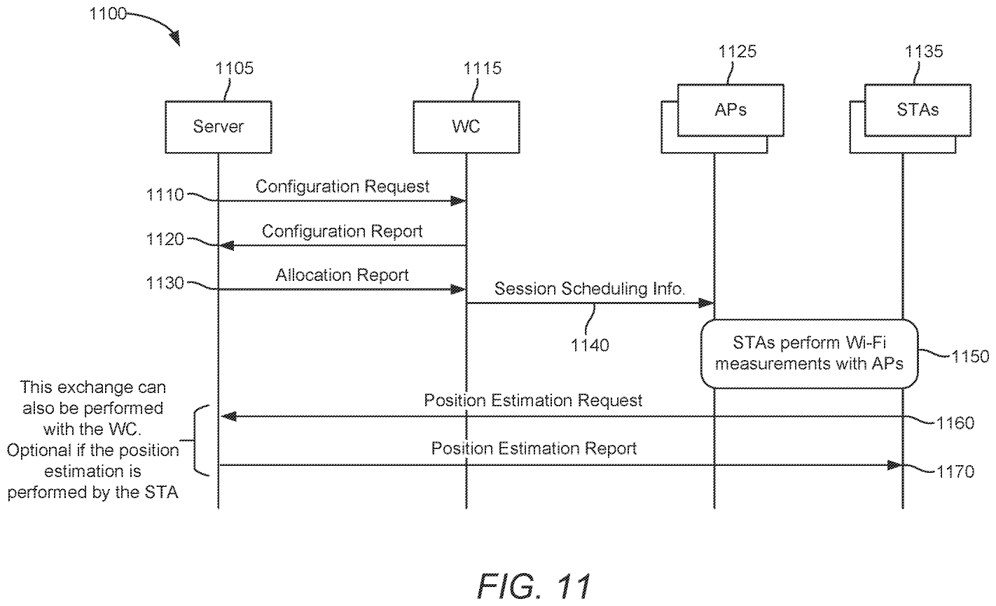

Wi-Fi ranging techniques are used in a variety of scenarios, including retail stores, warehouses, and other large commercial venues with many APs. FIG. 10 is a diagram 1000 illustrating an example grid of Wi-Fi APs (some of which are identified by reference number 1010) that may deployed in an industrial retail store or warehouse, according to aspects of the disclosure. An industrial retail store or warehouse can typically be as large as 70,000 square feet or more. The three-by-four grid of APs 1010 illustrated in FIG. 10 may be separated by 24 to 25 meters (m) (around 80 feet), providing a coverage area of around 75,000 to 80,000 square feet.

Even with just 20 target devices or STAs, nearly 240 ranging sessions would need to be performed between all the possible STA-to-AP links. Currently, for 80 MHz Wi-Fi channels, there are only four such unique channels in the spectrum, meaning that there would be 60 (simultaneous) ranging sessions per unique channel in the scenario illustrated in FIG. 10. For 160 MHz Wi-Fi channels, there are only two such unique channels, meaning that there would be 120 (simultaneous) ranging sessions per unique channel in the scenario illustrated in FIG. 10.

FIG. 10 further illustrates an upper-layer device referred to as a Wi-Fi controller (WC) 1020. The WC may be managed by the store/warehouse. This controller can manage the network of APs 1010 deployed across the area, in terms of frequency planning, channel access, recording user logs, etc.

The following techniques disclosed herein are generally directed to scheduling schemes in the type of industrial scenario illustrated in FIG. 10, along with hybridization with 5G-NR measurements to improve positioning accuracy.

In a first technique described herein, the WC (e.g., WC 1020) schedules unicast ranging sessions between STAs (e.g., ISTAs) and APs (e.g., RSTAs). These unicast sessions may be either non-TB ranging sessions (as illustrated in FIGS. 5 and 6) or TB ranging sessions without MU-MIMO (as illustrated in FIGS. 7 and 8). In this technique, the WC requests the STAs for certain initial parameters. The parameters may include (1) the importance of the STA (the store/warehouse can rank STAs in terms of how important their position estimate is), (2) mobility information (if available), (3) power consumption status, (4) desired latency, (5) desired position accuracy, and/or (6) a list of APs with which the STA wishes to perform measurements. Referring to the last parameter, a STA may create this list through its own proprietary methods. For example, the list may be based on a minimum signal-to-noise-ratio (SNR) threshold, a random sample consensus (RANSAC)-based grouping of APs, and/or based on the version compatibility of the standard (common capabilities are supported between the AP and the STA).

The WC can then assign a priority order to the STAs on the basis of the above parameters. Unicast ranging sessions may then be scheduled based on this order. The WC can also schedule frequency-planning so that multiple STA-to-AP links can perform measurements on the same channel simultaneously. This may be based on an interference power (or SINR) threshold that can be tolerated by the links. The WC may also adjust the transmit power of the APs to minimize interference between links and allow frequency-multiplexing.

With continued reference to the unicast scheduling technique, the WC may identify a group of STAs that wish to perform measurements with a common AP (i.e., the same AP). A group may be identified simply through prior knowledge of the coarse positions of the STAs, such that co-located STAs are grouped together. A group may also or alternatively be identified through the parameters provided by the STAs (e.g., the list of APs with which the STAs wish to perform measurements). The WC may then schedule a TB-based ranging session (as illustrated in FIGS. 7 and 8) between that group of STAs and the common AP.

In an aspect, with continued reference to the unicast scheduling technique, the WC may schedule one or more STAs having higher priority with more frequent ranging sessions than other STAs. This could occur when the STA(s) impose a very low latency requirement, are highly mobile, or are simply of higher importance. Similarly, some STAs with lower priority may be scheduled less frequent ranging sessions. For instance, a first STA may be scheduled to perform measurements 10 times every minute, while a second STA does so once every minute.

In a second technique described herein (referred to as multi-user scheduling), the WC schedules multi-user ranging sessions between STAs (e.g., ISTAs) and APs (e.g., RSTAs). Although prioritizing STAs and grouping them per AP can reduce latency and overhead, unicast ranging is still a slower process in dense and large-scale environments. Multi-user positioning (as illustrated in FIG. 9) can significantly help to decrease this overhead.

As per the IEEE 802.11az standard, a maximum of eight STAs (ISTAs) can be scheduled over a MU-MIMO transmission. In this scenario, the WC needs to take into account the following additional aspects while grouping STAs. First, for a given AP, the WC considers a set of STAs that have been grouped together (as described above). Second, the WC identifies sub-groups of STAs (e.g., up to eight) of the set of STAs based on their spatial multiplexing capability (the number of unique spatial streams is given by the rank of the channel matrix, which in turn requires channel estimation on the downlink, and is sent back to the AP on the uplink), which in turn is dependent on the channel state information on the downlink. This channel state information is provided by the STAs on the uplink through compressed beamforming feedback (CBF) reports. The WC then schedules an MU-MIMO ranging sessions (as illustrated in FIG. 9) between these sub-groups of STAs and the common AP. The WC can then schedule non-TB unicast ranging sessions (as illustrated in FIGS. 5 and 6) between the remaining STAs in the group and the common AP.

In a third technique described herein (referred to as server-assisted scheduling), Wi-Fi-based ranging sessions can be hybridized with NR-based positioning session and computations can be offloaded to a network server. Hybridizing positioning measurements across technologies can help improve the position accuracy. Here, 5G NR and Wi-Fi hybridization is considered for a large-scale industrial scenario (e.g., a store or warehouse).

In this technique, a private server (e.g., belonging to the store/warehouse operator) or a connected intelligent edge (CIE) server can assist with such hybridization schemes. For instance, the WC can offload the grouping strategy decisions to the server, which in turn can use proprietary and more advanced techniques (such as machine learning-based strategies) to provide the WC with more efficient grouping strategies for the STAs and their mapping with the APs.

FIG. 11 is a call flow 1100 illustrating an example of server-assisted scheduling without NR hybridization, according to aspects of the disclosure. In this scenario, a server 1105 (e.g., a private server or CIE server) assists the WC 1115 with STA grouping and other scheduling tasks. As shown in FIG. 11, at stage 1110, the server 1105 sends a configuration request to the WC 1115. The configuration request may request (1) the capability information regarding the APs 1125 and STAs 1135, (2) their currently known positions, (3) the STAs'1135 initial parameters (described above with reference to the unicast scheduling technique), (4) the priority order of the STAs 1135 being used by the WC 1115, and/or (5) the positioning measurements obtained by the STAs 1135 (if available). The positioning measurements may include RTT time-difference measurements, AoA measurements, AoD measurements, TDOA measurements, round-trip-phase (RTP) measurements, and/or the like. At stage 1120, the WC 1115 transmits the requested information (to the extent available) to the server 1105 in a configuration report.

The server 1105 then transmits, at stage 1130, an allocation report (also referred to as a scheduling report) to the WC 1115. The allocation report includes the server's 1105 own grouping strategies and scheduling information. The allocation report can also include mappings between the STAs 1135 and APs 1125 (i.e., which STAs 1135 should perform positioning measurements with which of the APs 1125). The WC 1115 can then use the information in the scheduling report to send session scheduling information to the involved APs 1125 at stage 1140. The scheduling information would be for TB ranging or MU-MIMO ranging procedures with the identified (sub-)groups of STAs 1135, as described above with reference to the unicast scheduling and multi-user scheduling techniques.

As shown in FIG. 11, after performing Wi-Fi-based ranging measurements with the identified APs 1125 at stage 1150, some or all of the STAs 1135 may transmit a position estimate request to the server 1105 at stage 1160. A position estimate request may include the positioning measurements obtained by an STA 1135 (e.g., its own and possibly the AP's 1125 if not reported to the server 1105 by the AP 1125). The server 1105 can then calculate the position(s) of the requesting STA(s) 1135 and send those position(s) back to the STA(s) 1135 at stage 1170. The STAs 1135 offloading the computational burden of determining the position estimate is especially beneficial for low-cost STAs 1135 (e.g., IoT devices) that may be deployed in industrial scenarios. Note that the position estimate message exchange could also be performed between the STA(s) 1135 and the WC 1115, and is optional if the position estimation is performed by the STA 1135.

With continued reference to the server-assisted scheduling technique, the server can also assist the STAs with a set of APs (for Wi-Fi) and a set of TRPs (for NR) with which they should perform positioning measurements. The STAs first provide the server (directly or indirectly) with some channel state feedback information and/or the intermediate RTT and/or AoA/AoD estimates.

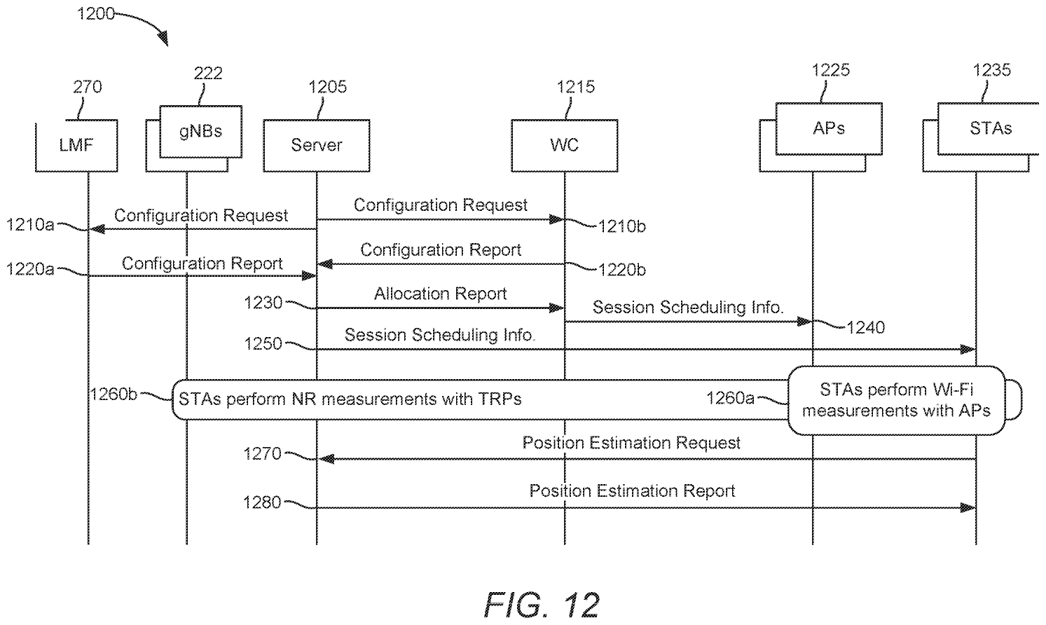

FIG. 12 is a call flow 1200 illustrating an example of server-assisted scheduling with NR hybridization, according to aspects of the disclosure. In this scenario, a server 1205 (e.g., a private server or CIE server) assists both the WC 1215 (e.g., WC 1115 in FIG. 11) and the STAs 1235. The server 1205 sends configuration requests to both the WC 1215 and an LMF 270 (or other location server) at stages 1210a and 1210b. The configuration request to the WC 1215 includes a request for a coarse location of the warehouse/store/etc. with which the WC 1215 is associated. The configuration request to the LMF 270 requests the PRS configurations and locations (and/or base station almanac (BSA)) of the base stations (e.g., gNBs 222) that are in the vicinity of that warehouse/store/etc. At stages 1220a and 1220b, the LMF 270 and WC 1215, respectively, respond with the requested information (if available) in configuration reports.

The server 1205 then transmits an allocation report (also referred to as a scheduling report) to the WC 1215 at stage 1230. As in FIG. 11, the allocation report includes the server's 1205 own grouping strategies and scheduling information. The allocation report can also include mappings between the STAs 1235 and APs 1225 (i.e., which STAs should perform positioning measurements with which of the APs 1225). The WC 1215 can then use the information in the scheduling report to send session scheduling information to the involved APs 1225 at stage 1240. The scheduling information would be for TB ranging or MU-MIMO ranging procedures with the identified (sub-)groups of STAs 1235, as described above with reference to the unicast scheduling and multi-user scheduling techniques.

At stage 1250, the server 1205 also sends session scheduling information to the STAs 1235 with a list of base stations/TRPs (e.g., gNBs 222) with which they should perform positioning measurements, along with the type of measurements to perform. This information is based on the information received from the LMF 270 in the configuration report.

As shown in FIG. 12, after performing Wi-Fi-based ranging measurements with the identified APs and NR-based positioning measurements with the identified TRPs at stages 1260a and 1260b, respectively, some or all of the STAs 1235 may transmit a position estimate request to the server 1205 at stage 1270. The position estimate request may include the positioning measurements obtained by an STA 1235 (e.g., its own and possibly the AP(s)' 1225 and/or gNB(s)' 222 if not reported to the server 1205 by the AP(s) 1225/gNB(s) 222). The server 1205 can then calculate the position(s) of the requesting STA(s) 1235 based on these measurements and send those position(s) back to the STA(s) 1235 at stage 1280. Through the exchange of a position estimation request and a position estimation report, the server 1205 can fuse the Wi-Fi and NR measurements and provide the STA 1235 with a final position estimate (STAs 1235 can offload the computational burden). This is beneficial for low-cost STAs 1235 (e.g., IoT devices) that may be deployed in industrial scenarios.

Note that the position estimate message exchange could also be performed with the WC or the LMF (e.g., over Long-Term Evolution (LTE) positioning protocol extension (LPPe) signaling). The position estimate message exchange is also optional if the position estimation is performed by the STA.

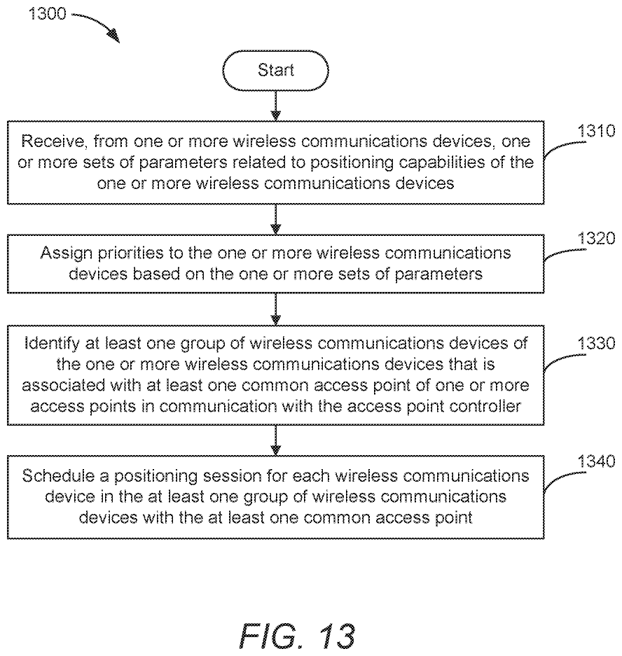

FIG. 13 illustrates an example method 1300 of wireless positioning, according to aspects of the disclosure. In an aspect, method 1300 may be performed by an access point controller (e.g., the WC described herein).

At 1310, the access point controller receives, from one or more wireless communications devices (e.g., STAs), one or more sets of parameters related to positioning capabilities of the one or more wireless communications devices. In an aspect, where the access point controller is a UE, operation 1310 may be performed by the one or more short-range wireless transceivers 320, the one or more processors 332, memory 340, and/or positioning component 342, any or all of which may be considered means for performing this operation. Where the access point controller is a base station, operation 1310 may be performed by the one or more short-range wireless transceivers 360, the one or more network transceivers 380, the one or more processors 384, memory 386, and/or positioning component 388, any or all of which may be considered means for performing this operation. Where the access point controller is a server or other network entity, operation 1310 may be performed by the one or more network transceivers 390, the one or more processors 394, memory 396, and/or positioning component 398, any or all of which may be considered means for performing this operation.

At 1320, the access point controller assigns priorities to the one or more wireless communications devices based on the one or more sets of parameters. In an aspect, where the access point controller is a UE, operation 1320 may be performed by the one or more short-range wireless transceivers 320, the one or more processors 332, memory 340, and/or positioning component 342, any or all of which may be considered means for performing this operation. Where the access point controller is a base station, operation 1320 may be performed by the one or more short-range wireless transceivers 360, the one or more network transceivers 380, the one or more processors 384, memory 386, and/or positioning component 388, any or all of which may be considered means for performing this operation. Where the access point controller is a server or other network entity, operation 1320 may be performed by the one or more network transceivers 390, the one or more processors 394, memory 396, and/or positioning component 398, any or all of which may be considered means for performing this operation.

At 1330, the access point controller identifies at least one group of wireless communications devices of the one or more wireless communications devices that is associated with at least one common access point of one or more access points in communication with the access point controller. In an aspect, where the access point controller is a UE, operation 1330 may be performed by the one or more short-range wireless transceivers 320, the one or more processors 332, memory 340, and/or positioning component 342, any or all of which may be considered means for performing this operation. Where the access point controller is a base station, operation 1330 may be performed by the one or more short-range wireless transceivers 360, the one or more network transceivers 380, the one or more processors 384, memory 386, and/or positioning component 388, any or all of which may be considered means for performing this operation. Where the access point controller is a server or other network entity, operation 1330 may be performed by the one or more network transceivers 390, the one or more processors 394, memory 396, and/or positioning component 398, any or all of which may be considered means for performing this operation.

At 1340, the access point controller schedules a positioning session for each wireless communications device in the at least one group of wireless communications devices with the at least one common access point. In an aspect, where the access point controller is a UE, operation 1340 may be performed by the one or more short-range wireless transceivers 320, the one or more processors 332, memory 340, and/or positioning component 342, any or all of which may be considered means for performing this operation. Where the access point controller is a base station, operation 1340 may be performed by the one or more short-range wireless transceivers 360, the one or more network transceivers 380, the one or more processors 384, memory 386, and/or positioning component 388, any or all of which may be considered means for performing this operation. Where the access point controller is a server or other network entity, operation 1340 may be performed by the one or more network transceivers 390, the one or more processors 394, memory 396, and/or positioning component 398, any or all of which may be considered means for performing this operation.

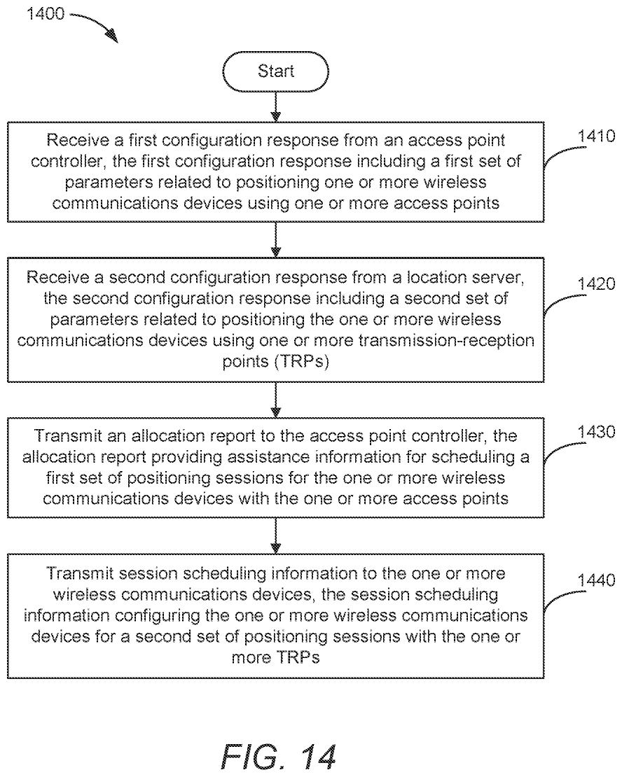

FIG. 14 illustrates an example method 1400 of wireless positioning, according to aspects of the disclosure. In an aspect, method 1400 may be performed by a server (e.g., as illustrated in and described with reference to FIGS. 11 and 12).

At 1410, the server receives a first configuration response from an access point controller, the first configuration response including a first set of parameters related to positioning one or more wireless communications devices (e.g., STAs) using one or more access points. In an aspect, operation 1410 may be performed by the one or more network transceivers 390, the one or more processors 394, memory 396, and/or positioning component 398, any or all of which may be considered means for performing this operation.

At 1420, the server receives a second configuration response from a location server, the second configuration response including a second set of parameters related to positioning the one or more wireless communications devices using one or more TRPs. In an aspect, operation 1420 may be performed by the one or more network transceivers 390, the one or more processors 394, memory 396, and/or positioning component 398, any or all of which may be considered means for performing this operation.

At 1430, the server transmits an allocation report to the access point controller, the allocation report providing assistance information for scheduling a first set of positioning sessions for the one or more wireless communications devices with the one or more access points. In an aspect, operation 1430 may be performed by the one or more network transceivers 390, the one or more processors 394, memory 396, and/or positioning component 398, any or all of which may be considered means for performing this operation.

At 1440, the server transmits session scheduling information to the one or more wireless communications devices, the session scheduling information configuring the one or more wireless communications devices for a second set of positioning sessions with the one or more TRPs. In an aspect, operation 1440 may be performed by the one or more network transceivers 390, the one or more processors 394, memory 396, and/or positioning component 398, any or all of which may be considered means for performing this operation.

As will be appreciated, a technical advantage of the methods 1300 and 1400 is improved positioning session s scheduling, in particular for large numbers of wireless communications devices, thereby improving scalability. In addition, contention and/or collisions between devices is reduced, which in turn reduces latency and power consumption. Moreover, there is an opportunity to prioritize some devices over others.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although cach dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:
Clause 1. A method of wireless positioning performed by an access point controller, comprising: receiving, from one or more wireless communications devices, one or more sets of parameters related to positioning capabilities of the one or more wireless communications devices; assigning priorities to the one or more wireless communications devices based on the one or more sets of parameters; identifying at least one group of wireless communications devices of the one or more wireless communications devices that is associated with at least one common access point of one or more access points in communication with the access point controller; and scheduling a positioning session for each wireless communications device in the at least one group of wireless communications devices with the at least one common access point.
Clause 2. The method of clause 1, wherein, for cach wireless communications device of the one or more wireless communications devices, the corresponding set of parameters of the one or more sets of parameters comprises: an importance of the wireless communications device, mobility information of the wireless communications device, a power consumption status of the wireless communications device, a desired latency of the positioning session, a desired accuracy of the positioning session, a list of access points with which the wireless communications device is interested in performing the positioning session, or any combination thereof.
Clause 3. The method of any of clauses 1 to 2, wherein scheduling the positioning session for each wireless communications device in the at least one group of wireless communications devices is based on frequency-planning to enable multiple wireless communications devices in the at least one group of wireless communications devices to perform positioning measurements on the same channel simultaneously.
Clause 4. The method of any of clauses 1 to 3, wherein scheduling the positioning session for each wireless communications device in the at least one group of wireless communications devices comprises instructing the at least one common access point to adjust a transmit power of the at least one common access point to minimize interference and permit frequency-multiplexing.
Clause 5. The method of any of clauses 1 to 4, wherein the at least one group of wireless communications devices is identified based on: coarse locations of wireless communications devices in the at least one group of wireless communications devices, a list of access points with which wireless communications devices in the at least one group of wireless communications devices are interested in performing positioning, or any combination thereof.
Clause 6. The method of any of clauses 1 to 5, wherein scheduling the positioning session for each wireless communications device in the at least one group of wireless communications devices comprises scheduling positioning sessions for higher priority wireless communications devices of the at least one group of wireless communications devices more frequently that positioning sessions for lower priority wireless communications devices of the at least one group of wireless communications devices.
Clause 7. The method of any of clauses 1 to 6, further comprising: transmitting a request to each of the one or more wireless communications devices for the one or more sets of parameters.
Clause 8. The method of any of clauses 1 to 7, wherein the positioning session for each wireless communications device in the at least one group of wireless communications devices comprises a unicast positioning session.
Clause 9. The method of any of clauses 1 to 7, wherein the positioning session for each wireless communications device in the at least one group of wireless communications devices comprises a multi-user positioning session.
Clause 10. The method of clause 9, wherein the at least one group of wireless communications devices comprises one or more sub-groups of wireless communications devices of the at least one group of wireless communications devices.
Clause 11. The method of clause 10, wherein the one or more sub-groups of wireless communications devices are selected based on spatial multiplexing capabilities of wireless communications devices in the one or more sub-groups of wireless communications devices.
Clause 12. The method of any of clauses 10 to 11, wherein scheduling the positioning session for each wireless communications device in the at least one group of wireless communications devices comprises scheduling a multi-user positioning session for each of the one or more sub-groups of wireless communications devices.
Clause 13. The method of any of clauses 10 to 12, wherein scheduling the positioning session for each wireless communications device in the at least one group of wireless communications devices comprises scheduling unicast positioning sessions for remaining wireless communications devices in the at least one group of wireless communications devices.
Clause 14. The method of any of clauses 9 to 13, wherein the multi-user positioning session comprises a multi-user multiple-input multiple-output (MU-MIMO) ranging session.
Clause 15. The method of any of clauses 1 to 14, further comprising: transmitting a configuration response to a server, the configuration response including a second set of parameters, the second set of parameters comprising: positioning capability information for the one or more wireless communications devices, positioning capability information for the one or more access points, current positions of the one or more wireless communications devices, current positions of the one or more access points, the one or more sets of parameters, the priorities assigned to the one or more wireless communications devices, one or more positioning measurements obtained by the one or more wireless communications devices, or any combination thereof.
Clause 16. The method of clause 15, wherein the one or more positioning measurements comprise: one or more round-trip-time (RTT) measurements obtained by the one or more wireless communications devices, one or more angle-of-arrival (AoA) measurements obtained by the one or more wireless communications devices, one or more angle-of-departure (AoD) measurements obtained by the one or more wireless communications devices, one or more time-difference-of-arrival (TDOA) measurements obtained by the one or more wireless communications devices, one or more round-trip-phase (RTP) measurements obtained by the one or more wireless communications devices, or any combination thereof.
Clause 17. The method of any of clauses 15 to 16, further comprising: receiving a configuration request from the server, wherein the configuration request requests the second set of parameters, and wherein the configuration response is transmitted in response to the configuration request.
Clause 18. The method of any of clauses 15 to 17, further comprising: receiving an allocation report from the server, the allocation report including: a grouping strategy for the one or more wireless communications devices, scheduling information for the one or more wireless communications devices, suggested mappings between the one or more wireless communications devices and the one or more access points, or any combination thereof.
Clause 19. The method of clause 18, wherein scheduling the positioning session for each wireless communications device in the at least one group of wireless communications devices is based on information in the allocation report.
Clause 20. The method of any of clauses 1 to 19, further comprising: receiving a position estimation request from at least one wireless communications device of the at least one group of wireless communications devices, the position estimation request including positioning measurements obtained by the at least one wireless communications device; and transmitting a position estimation response to the at least one wireless communications device, the position estimation response including an estimated position of the at least one wireless communications device.
Clause 21. A method of wireless positioning performed by a server, comprising: receiving a first configuration response from an access point controller, the first configuration response including a first set of parameters related to positioning one or more wireless communications devices using one or more access points; receiving a second configuration response from a location server, the second configuration response including a second set of parameters related to positioning the one or more wireless communications devices using one or more transmission-reception points (TRPs); transmitting an allocation report to the access point controller, the allocation report providing assistance information for scheduling a first set of positioning sessions for the one or more wireless communications devices with the one or more access points; and transmitting session scheduling information to the one or more wireless communications devices, the session scheduling information configuring the one or more wireless communications devices for a second set of positioning sessions with the one or more TRPs.
Clause 22. The method of clause 21, wherein the first set of parameters comprises: positioning capability information for the one or more wireless communications devices, positioning capability information for the one or more access points, current positions of the one or more wireless communications devices, current positions of the one or more access points, one or more sets of parameters related to positioning capabilities of the one or more wireless communications devices, the priorities assigned to the one or more wireless communications devices, one or more positioning measurements obtained by the one or more wireless communications devices, or any combination thereof.
Clause 23. The method of clause 22, wherein the one or more positioning measurements comprise: one or more round-trip-time (RTT) measurements obtained by the one or more wireless communications devices, one or more angle-of-arrival (AoA) measurements obtained by the one or more wireless communications devices, one or more angle-of-departure (AoD) measurements obtained by the one or more wireless communications devices, one or more time-difference-of-arrival (TDOA) measurements obtained by the one or more wireless communications devices, one or more round-trip-phase (RTP) measurements obtained by the one or more wireless communications devices, or any combination thereof.
Clause 24. The method of any of clauses 21 to 23, wherein the second set of parameters comprises: positioning reference signal (PRS) configurations of the one or more TRPs, locations of the one or more TRPs, a base station almanac (BSA) for the one or more TRPS, or any combination thereof.
Clause 25. The method of any of clauses 21 to 24, wherein the allocation report includes: a grouping strategy for the one or more wireless communications devices, scheduling information for the one or more wireless communications devices, suggested mappings between the one or more wireless communications devices and the one or more access points, or any combination thereof.
Clause 26. The method of any of clauses 21 to 25, wherein the session scheduling information comprises: positioning reference signal (PRS) configurations of the one or more TRPs, locations of the one or more TRPs, a base station almanac (BSA) for the one or more TRPS, or any combination thereof.
Clause 27. The method of any of clauses 21 to 26, further comprising: transmitting a first configuration request to the access point controller, wherein the first configuration request requests the first set of parameters, and wherein the first configuration response is received in response to the first configuration request; and transmitting a second configuration request to the location server, wherein the second configuration request requests the second set of parameters, and wherein the second configuration response is received in response to the second configuration request.
Clause 28. The method of any of clauses 21 to 27, further comprising: receiving a position estimation request from at least one wireless communications device of the one or more wireless communications devices, the position estimation request including positioning measurements of the one or more access points, the one or more TRPs, or both obtained by the at least one wireless communications device; and transmitting a position estimation response to the at least one wireless communications device, the position estimation response including an estimated position of the at least one wireless communications device determined based on the positioning measurements of the one or more access points, the one or more TRPs, or both obtained by the at least one wireless communications device.
Clause 29. An access point controller, comprising: a memory; at least one transceiver; and at least one processor communicatively coupled to the memory and the at least one transceiver, the at least one processor configured to: receive, via the at least one transceiver, from one or more wireless communications devices, one or more sets of parameters related to positioning capabilities of the one or more wireless communications devices; assign priorities to the one or more wireless communications devices based on the one or more sets of parameters; identify at least one group of wireless communications devices of the one or more wireless communications devices that is associated with at least one common access point of one or more access points in communication with the access point controller; and schedule a positioning session for each wireless communications device in the at least one group of wireless communications devices with the at least one common access point.
Clause 30. The access point controller of clause 29, wherein, for each wireless communications device of the one or more wireless communications devices, the corresponding set of parameters of the one or more sets of parameters comprises: an importance of the wireless communications device, mobility information of the wireless communications device, a power consumption status of the wireless communications device, a desired latency of the positioning session, a desired accuracy of the positioning session, a list of access points with which the wireless communications device is interested in performing the positioning session, or any combination thereof.
Clause 31. The access point controller of any of clauses 29 to 30, wherein the positioning session for each wireless communications device in the at least one group of wireless communications devices is scheduled based on frequency-planning to enable multiple wireless communications devices in the at least one group of wireless communications devices to perform positioning measurements on the same channel simultaneously.
Clause 32. The access point controller of any of clauses 29 to 31, wherein the at least one processor configured to schedule the positioning session for each wireless communications device in the at least one group of wireless communications devices comprises the at least one processor configured to instruct the at least one common access point to adjust a transmit power of the at least one common access point to minimize interference and permit frequency-multiplexing.
Clause 33. The access point controller of any of clauses 29 to 32, wherein the at least one group of wireless communications devices is identified based on: locations of wireless communications devices in the at least one group of wireless communications devices, a list of access points with which wireless communications devices in the at least one group of wireless communications devices are interested in performing positioning, or any combination thereof.
Clause 34. The access point controller of any of clauses 29 to 33, wherein the at least one processor configured to schedule the positioning session for each wireless communications device in the at least one group of wireless communications devices comprises the at least one processor configured to schedule positioning sessions for higher priority wireless communications devices of the at least one group of wireless communications devices more frequently that positioning sessions for lower priority wireless communications devices of the at least one group of wireless communications devices.
Clause 35. The access point controller of any of clauses 29 to 34, wherein the at least one processor is further configured to: transmit, via the at least one transceiver, a request to each of the one or more wireless communications devices for the one or more sets of parameters.
Clause 36. The access point controller of any of clauses 29 to 35, wherein the positioning session for each wireless communications device in the at least one group of wireless communications devices comprises a unicast positioning session.
Clause 37. The access point controller of any of clauses 29 to 35, wherein the positioning session for each wireless communications device in the at least one group of wireless communications devices comprises a multi-user positioning session.
Clause 38. The access point controller of clause 37, wherein the at least one group of wireless communications devices comprises one or more sub-groups of wireless communications devices of the at least one group of wireless communications devices.
Clause 39. The access point controller of clause 38, wherein the one or more sub-groups of wireless communications devices are selected based on spatial multiplexing capabilities of wireless communications devices in the one or more sub-groups of wireless communications devices.
Clause 40. The access point controller of any of clauses 38 to 39, wherein the at least one processor configured to schedule the positioning session for each wireless communications device in the at least one group of wireless communications devices comprises the at least one processor configured to schedule a multi-user positioning session for each of the one or more sub-groups of wireless communications devices.
Clause 41. The access point controller of any of clauses 38 to 40, wherein the at least one processor configured to schedule the positioning session for each wireless communications device in the at least one group of wireless communications devices comprises the at least one processor configured to schedule unicast positioning sessions for remaining wireless communications devices in the at least one group of wireless communications devices.
Clause 42. The access point controller of any of clauses 37 to 41, wherein the multi-user positioning session comprises a multi-user multiple-input multiple-output (MU-MIMO) ranging session.
Clause 43. The access point controller of any of clauses 29 to 42, wherein the at least one processor is further configured to: transmit, via the at least one transceiver, a configuration response to a server, the configuration response including a second set of parameters, the second set of parameters comprising: positioning capability information for the one or more wireless communications devices, positioning capability information for the one or more access points, current positions of the one or more wireless communications devices, current positions of the one or more access points, the one or more sets of parameters, the priorities assigned to the one or more wireless communications devices, one or more positioning measurements obtained by the one or more wireless communications devices, or any combination thereof.
Clause 44. The access point controller of clause 43, wherein the one or more positioning measurements comprise: one or more round-trip-time (RTT) measurements obtained by the one or more wireless communications devices, one or more angle-of-arrival (AoA) measurements obtained by the one or more wireless communications devices, one or more angle-of-departure (AoD) measurements obtained by the one or more wireless communications devices, one or more time-difference-of-arrival (TDOA) measurements obtained by the one or more wireless communications devices, one or more round-trip-phase (RTP) measurements obtained by the one or more wireless communications devices, or any combination thereof.
Clause 45. The access point controller of any of clauses 43 to 44, wherein the at least one processor is further configured to: receive, via the at least one transceiver, a configuration request from the server, wherein the configuration request requests the second set of parameters, and wherein the configuration response is transmitted in response to the configuration request.
Clause 46. The access point controller of any of clauses 43 to 45, wherein the at least one processor is further configured to: receive, via the at least one transceiver, an allocation report from the server, the allocation report including: a grouping strategy for the one or more wireless communications devices, scheduling information for the one or more wireless communications devices, suggested mappings between the one or more wireless communications devices and the one or more access points, or any combination thereof.
Clause 47. The access point controller of clause 46, wherein the positioning session for each wireless communications device in the at least one group of wireless communications devices is scheduled based on information in the allocation report.
Clause 48. The access point controller of any of clauses 29 to 47, wherein the at least one processor is further configured to: receive, via the at least one transceiver, a position estimation request from at least one wireless communications device of the at least one group of wireless communications devices, the position estimation request including positioning measurements obtained by the at least one wireless communications device; and transmit, via the at least one transceiver, a position estimation response to the at least one wireless communications device, the position estimation response including an estimated position of the at least one wireless communications device.
Clause 49. A server, comprising: a memory; at least one transceiver; and at least one processor communicatively coupled to the memory and the at least one transceiver, the at least one processor configured to: receive, via the at least one transceiver, a first configuration response from an access point controller, the first configuration response including a first set of parameters related to positioning one or more wireless communications devices using one or more access points; receive, via the at least one transceiver, a second configuration response from a location server, the second configuration response including a second set of parameters related to positioning the one or more wireless communications devices using one or more transmission-reception points (TRPs); transmit, via the at least one transceiver, an allocation report to the access point controller, the allocation report providing assistance information for scheduling a first set of positioning sessions for the one or more wireless communications devices with the one or more access points; and transmit, via the at least one transceiver, session scheduling information to the one or more wireless communications devices, the session scheduling information configuring the one or more wireless communications devices for a second set of positioning sessions with the one or more TRPs.
Clause 50. The server of clause 49, wherein the first set of parameters comprises: positioning capability information for the one or more wireless communications devices, positioning capability information for the one or more access points, current positions of the one or more wireless communications devices, current positions of the one or more access points, one or more sets of parameters related to positioning capabilities of the one or more wireless communications devices, the priorities assigned to the one or more wireless communications devices, one or more positioning measurements obtained by the one or more wireless communications devices, or any combination thereof.
Clause 51. The server of clause 50, wherein the one or more positioning measurements comprise: one or more round-trip-time (RTT) measurements obtained by the one or more wireless communications devices, one or more angle-of-arrival (AoA) measurements obtained by the one or more wireless communications devices, one or more angle-of-departure (AoD) measurements obtained by the one or more wireless communications devices, one or more time-difference-of-arrival (TDOA) measurements obtained by the one or more wireless communications devices, one or more round-trip-phase (RTP) measurements obtained by the one or more wireless communications devices, or any combination thereof.
Clause 52. The server of any of clauses 49 to 51, wherein the second set of parameters comprises: positioning reference signal (PRS) configurations of the one or more TRPs, locations of the one or more TRPs, a base station almanac (BSA) for the one or more TRIPS, or any combination thereof.
Clause 53. The server of any of clauses 49 to 52, wherein the allocation report includes: a grouping strategy for the one or more wireless communications devices, scheduling information for the one or more wireless communications devices, suggested mappings between the one or more wireless communications devices and the one or more access points, or any combination thereof.
Clause 54. The server of any of clauses 49 to 53, wherein the session scheduling information comprises: positioning reference signal (PRS) configurations of the one or more TRPs, locations of the one or more TRPs, a base station almanac (BSA) for the one or more TRPS, or any combination thereof.
Clause 55. The server of any of clauses 49 to 54, wherein the at least one processor is further configured to: transmit, via the at least one transceiver, a first configuration request to the access point controller, wherein the first configuration request requests the first set of parameters, and wherein the first configuration response is received in response to the first configuration request; and transmit, via the at least one transceiver, a second configuration request to the location server, wherein the second configuration request requests the second set of parameters, and wherein the second configuration response is received in response to the second configuration request.
Clause 56. The server of any of clauses 49 to 55, wherein the at least one processor is further configured to: receive, via the at least one transceiver, a position estimation request from at least one wireless communications device of the one or more wireless communications devices, the position estimation request including positioning measurements of the one or more access points, the one or more TRPs, or both obtained by the at least one wireless communications device; and transmit, via the at least one transceiver, a position estimation response to the at least one wireless communications device, the position estimation response including an estimated position of the at least one wireless communications device determined based on the positioning measurements of the one or more access points, the one or more TRPs, or both obtained by the at least one wireless communications device.
Clause 57. An access point controller, comprising: means for receiving, from one or more wireless communications devices, one or more sets of parameters related to positioning capabilities of the one or more wireless communications devices; means for assigning priorities to the one or more wireless communications devices based on the one or more sets of parameters; means for identifying at least one group of wireless communications devices of the one or more wireless communications devices that is associated with at least one common access point of one or more access points in communication with the access point controller; and means for scheduling a positioning session for each wireless communications device in the at least one group of wireless communications devices with the at least one common access point.
Clause 58. The access point controller of clause 57, wherein, for each wireless communications device of the one or more wireless communications devices, the corresponding set of parameters of the one or more sets of parameters comprises: an importance of the wireless communications device, mobility information of the wireless communications device, a power consumption status of the wireless communications device, a desired latency of the positioning session, a desired accuracy of the positioning session, a list of access points with which the wireless communications device is interested in performing the positioning session, or any combination thereof.
Clause 59. The access point controller of any of clauses 57 to 58, wherein the positioning session for each wireless communications device in the at least one group of wireless communications devices is scheduled based on frequency-planning to enable multiple wireless communications devices in the at least one group of wireless communications devices to perform positioning measurements on the same channel simultaneously,
Clause 60. The access point controller of any of clauses 57 to 59, wherein the means for scheduling the positioning session for each wireless communications device in the at least one group of wireless communications devices comprises means for instructing the at least one common access point to adjust a transmit power of the at least one common access point to minimize interference and permit frequency-multiplexing.
Clause 61. The access point controller of any of clauses 57 to 60, wherein the at least one group of wireless communications devices is identified based on: locations of wireless communications devices in the at least one group of wireless communications devices, a list of access points with which wireless communications devices in the at least one group of wireless communications devices are interested in performing positioning, or any combination thereof.
Clause 62. The access point controller of any of clauses 57 to 61, wherein the means for scheduling the positioning session for each wireless communications device in the at least one group of wireless communications devices comprises means for scheduling positioning sessions for higher priority wireless communications devices of the at least one group of wireless communications devices more frequently that positioning sessions for lower priority wireless communications devices of the at least one group of wireless communications devices.
Clause 63. The access point controller of any of clauses 57 to 62, further comprising: means for transmitting a request to each of the one or more wireless communications devices for the one or more sets of parameters.
Clause 64. The access point controller of any of clauses 57 to 63, wherein the positioning session for each wireless communications device in the at least one group of wireless communications devices comprises a unicast positioning session.
Clause 65. The access point controller of any of clauses 57 to 63, wherein the positioning session for each wireless communications device in the at least one group of wireless communications devices comprises a multi-user positioning session.
Clause 66. The access point controller of clause 65, wherein the at least one group of wireless communications devices comprises one or more sub-groups of wireless communications devices of the at least one group of wireless communications devices.
Clause 67. The access point controller of clause 66, wherein the one or more sub-groups of wireless communications devices are selected based on spatial multiplexing capabilities of wireless communications devices in the one or more sub-groups of wireless communications devices.
Clause 68. The access point controller of any of clauses 66 to 67, wherein the means for scheduling the positioning session for each wireless communications device in the at least one group of wireless communications devices comprises means for scheduling a multi-user positioning session for each of the one or more sub-groups of wireless communications devices.
Clause 69. The access point controller of any of clauses 66 to 68, wherein the means for scheduling the positioning session for each wireless communications device in the at least one group of wireless communications devices comprises means for scheduling unicast positioning sessions for remaining wireless communications devices in the at least one group of wireless communications devices.
Clause 70. The access point controller of any of clauses 65 to 69, wherein the multi-user positioning session comprises a multi-user multiple-input multiple-output (MU-MIMO) ranging session.
Clause 71. The access point controller of any of clauses 57 to 70, further comprising: means for transmitting a configuration response to a server, the configuration response including a second set of parameters, the second set of parameters comprising: positioning capability information for the one or more wireless communications devices, positioning capability information for the one or more access points, current positions of the one or more wireless communications devices, current positions of the one or more access points, the one or more sets of parameters, the priorities assigned to the one or more wireless communications devices, one or more positioning measurements obtained by the one or more wireless communications devices, or any combination thereof.
Clause 72. The access point controller of clause 71, wherein the one or more positioning measurements comprise: one or more round-trip-time (RTT) measurements obtained by the one or more wireless communications devices, one or more angle-of-arrival (AoA) measurements obtained by the one or more wireless communications devices, one or more angle-of-departure (AoD) measurements obtained by the one or more wireless communications devices, one or more time-difference-of-arrival (TDOA) measurements obtained by the one or more wireless communications devices, one or more round-trip-phase (RTP) measurements obtained by the one or more wireless communications devices, or any combination thereof.
Clause 73. The access point controller of any of clauses 71 to 72, further comprising: means for receiving a configuration request from the server, wherein the configuration request requests the second set of parameters, and wherein the configuration response is transmitted in response to the configuration request.
Clause 74. The access point controller of any of clauses 71 to 73, further comprising: means for receiving an allocation report from the server, the allocation report including: a grouping strategy for the one or more wireless communications devices, scheduling information for the one or more wireless communications devices, suggested mappings between the one or more wireless communications devices and the one or more access points, or any combination thereof.
Clause 75. The access point controller of clause 74, wherein the positioning session for each wireless communications device in the at least one group of wireless communications devices is scheduled based on information in the allocation report.
Clause 76. The access point controller of any of clauses 57 to 75, further comprising: means for receiving a position estimation request from at least one wireless communications device of the at least one group of wireless communications devices, the position estimation request including positioning measurements obtained by the at least one wireless communications device; and means for transmitting a position estimation response to the at least one wireless communications device, the position estimation response including an estimated position of the at least one wireless communications device.
Clause 77. A server, comprising: means for receiving a first configuration response from an access point controller, the first configuration response including a first set of parameters related to positioning one or more wireless communications devices using one or more access points; means for receiving a second configuration response from a location server, the second configuration response including a second set of parameters related to positioning the one or more wireless communications devices using one or more transmission-reception points (TRPs); means for transmitting an allocation report to the access point controller, the allocation report providing assistance information for scheduling a first set of positioning sessions for the one or more wireless communications devices with the one or more access points; and means for transmitting session scheduling information to the one or more wireless communications devices, the session scheduling information configuring the one or more wireless communications devices for a second set of positioning sessions with the one or more TRPs.
Clause 78. The server of clause 77, wherein the first set of parameters comprises: positioning capability information for the one or more wireless communications devices, positioning capability information for the one or more access points, current positions of the one or more wireless communications devices, current positions of the one or more access points, one or more sets of parameters related to positioning capabilities of the one or more wireless communications devices, the priorities assigned to the one or more wireless communications devices, one or more positioning measurements obtained by the one or more wireless communications devices, or any combination thereof.
Clause 79. The server of clause 78, wherein the one or more positioning measurements comprise: one or more round-trip-time (RTT) measurements obtained by the one or more wireless communications devices, one or more angle-of-arrival (AoA) measurements obtained by the one or more wireless communications devices, one or more angle-of-departure (AoD) measurements obtained by the one or more wireless communications devices, one or more time-difference-of-arrival (TDOA) measurements obtained by the one or more wireless communications devices, one or more round-trip-phase (RTP) measurements obtained by the one or more wireless communications devices, or any combination thereof.
Clause 80. The server of any of clauses 77 to 79, wherein the second set of parameters comprises: positioning reference signal (PRS) configurations of the one or more TRPs, locations of the one or more TRPs, a base station almanac (BSA) for the one or more TRPS, or any combination thereof.
Clause 81. The server of any of clauses 77 to 80, wherein the allocation report includes: a grouping strategy for the one or more wireless communications devices, scheduling information for the one or more wireless communications devices, suggested mappings between the one or more wireless communications devices and the one or more access points, or any combination thereof.
Clause 82. The server of any of clauses 77 to 81, wherein the session scheduling information comprises: positioning reference signal (PRS) configurations of the one or more TRPs, locations of the one or more TRPs, a base station almanac (BSA) for the one or more TRPS, or any combination thereof.
Clause 83, The server of any of clauses 77 to 82, further comprising: means for transmitting a first configuration request to the access point controller, wherein the first configuration request requests the first set of parameters, and wherein the first configuration response is received in response to the first configuration request; and means for transmitting a second configuration request to the location server, wherein the second configuration request requests the second set of parameters, and wherein the second configuration response is received in response to the second configuration request.
Clause 84. The server of any of clauses 77 to 83, further comprising: means for receiving a position estimation request from at least one wireless communications device of the one or more wireless communications devices, the position estimation request including positioning measurements of the one or more access points, the one or more TRPs, or both obtained by the at least one wireless communications device; and means for transmitting a position estimation response to the at least one wireless communications device, the position estimation response including an estimated position of the at least one wireless communications device determined based on the positioning measurements of the one or more access points, the one or more TRPs, or both obtained by the at least one wireless communications device.
Clause 85. A non-transitory computer-readable medium storing computer-executable instructions that, when executed by an access point controller, cause the access point controller to: receive, from one or more wireless communications devices, one or more sets of parameters related to positioning capabilities of the one or more wireless communications devices; assign priorities to the one or more wireless communications devices based on the one or more sets of parameters; identify at least one group of wireless communications devices of the one or more wireless communications devices that is associated with at least one common access point of one or more access points in communication with the access point controller; and schedule a positioning session for each wireless communications device in the at least one group of wireless communications devices with the at least one common access point.
Clause 86. The non-transitory computer-readable medium of clause 85, wherein, for each wireless communications device of the one or more wireless communications devices, the corresponding set of parameters of the one or more sets of parameters comprises: an importance of the wireless communications device, mobility information of the wireless communications device, a power consumption status of the wireless communications device, a desired latency of the positioning session, a desired accuracy of the positioning session, a list of access points with which the wireless communications device is interested in performing the positioning session, or any combination thereof.
Clause 87. The non-transitory computer-readable medium of any of clauses 85 to 86, wherein the positioning session for each wireless communications device in the at least one group of wireless communications devices is scheduled based on frequency-planning to enable multiple wireless communications devices in the at least one group of wireless communications devices to perform positioning measurements on the same channel simultaneously.
Clause 88. The non-transitory computer-readable medium of any of clauses 85 to 87, wherein the computer-executable instructions that, when executed by the access point controller, cause the access point controller to schedule the positioning session for each wireless communications device in the at least one group of wireless communications devices comprise computer-executable instructions that, when executed by the access point controller, cause the access point controller to instruct the at least one common access point to adjust a transmit power of the at least one common access point to minimize interference and permit frequency-multiplexing.
Clause 89. The non-transitory computer-readable medium of any of clauses 85 to 88, wherein the at least one group of wireless communications devices is identified based on: locations of wireless communications devices in the at least one group of wireless communications devices, a list of access points with which wireless communications devices in the at least one group of wireless communications devices are interested in performing positioning, or any combination thereof.
Clause 90. The non-transitory computer-readable medium of any of clauses 85 to 89, wherein the computer-executable instructions that, when executed by the access point controller, cause the access point controller to schedule the positioning session for each wireless communications device in the at least one group of wireless communications devices comprise computer-executable instructions that, when executed by the access point controller, cause the access point controller to scheduling positioning sessions for higher priority wireless communications devices of the at least one group of wireless communications devices more frequently that positioning sessions for lower priority wireless communications devices of the at least one group of wireless communications devices.
Clause 91. The non-transitory computer-readable medium of any of clauses 85 to 90, further comprising computer-executable instructions that, when executed by the access point controller, cause the access point controller to: transmit a request to each of the one or more wireless communications devices for the one or more sets of parameters.
Clause 92. The non-transitory computer-readable medium of any of clauses 85 to 91, wherein the positioning session for each wireless communications device in the at least one group of wireless communications devices comprises a unicast positioning session.
Clause 93. The non-transitory computer-readable medium of any of clauses 85 to 91, wherein the positioning session for each wireless communications device in the at least one group of wireless communications devices comprises a multi-user positioning session.
Clause 94. The non-transitory computer-readable medium of clause 93, wherein the at least one group of wireless communications devices comprises one or more sub-groups of wireless communications devices of the at least one group of wireless communications devices.
Clause 95. The non-transitory computer-readable medium of clause 94, wherein the one or more sub-groups of wireless communications devices are selected based on spatial multiplexing capabilities of wireless communications devices in the one or more sub-groups of wireless communications devices.
Clause 96. The non-transitory computer-readable medium of any of clauses 94 to 95, wherein the computer-executable instructions that, when executed by the access point controller, cause the access point controller to schedule the positioning session for each wireless communications device in the at least one group of wireless communications devices comprise computer-executable instructions that, when executed by the access point controller, cause the access point controller to schedule a multi-user positioning session for each of the one or more sub-groups of wireless communications devices.
Clause 97. The non-transitory computer-readable medium of any of clauses 94 to 96, wherein the computer-executable instructions that, when executed by the access point controller, cause the access point controller to schedule the positioning session for each wireless communications device in the at least one group of wireless communications devices comprise computer-executable instructions that, when executed by the access point controller, cause the access point controller to scheduling unicast positioning sessions for remaining wireless communications devices in the at least one group of wireless communications devices.
Clause 98. The non-transitory computer-readable medium of any of clauses 93 to 97, wherein the multi-user positioning session comprises a multi-user multiple-input multiple-output (MU-MIMO) ranging session.
Clause 99. The non-transitory computer-readable medium of any of clauses 85 to 98, further comprising computer-executable instructions that, when executed by the access point controller, cause the access point controller to: transmit a configuration response to a server, the configuration response including a second set of parameters, the second set of parameters comprising: positioning capability information for the one or more wireless communications devices, positioning capability information for the one or more access points, current positions of the one or more wireless communications devices, current positions of the one or more access points, the one or more sets of parameters, the priorities assigned to the one or more wireless communications devices, one or more positioning measurements obtained by the one or more wireless communications devices, or any combination thereof.
Clause 100. The non-transitory computer-readable medium of clause 99, wherein the one or more positioning measurements comprise: one or more round-trip-time (RTT) measurements obtained by the one or more wireless communications devices, one or more angle-of-arrival (AoA) measurements obtained by the one or more wireless communications devices, one or more angle-of-departure (AoD) measurements obtained by the one or more wireless communications devices, one or more time-difference-of-arrival (TDOA) measurements obtained by the one or more wireless communications devices, one or more round-trip-phase (RTP) measurements obtained by the one or more wireless communications devices, or any combination thereof.
Clause 101. The non-transitory computer-readable medium of any of clauses 99 to 100, further comprising computer-executable instructions that, when executed by the access point controller, cause the access point controller to: receive a configuration request from the server, wherein the configuration request requests the second set of parameters, and wherein the configuration response is transmitted in response to the configuration request.
Clause 102. The non-transitory computer-readable medium of any of clauses 99 to 101, further comprising computer-executable instructions that, when executed by the access point controller, cause the access point controller to: receive an allocation report from the server, the allocation report including: a grouping strategy for the one or more wireless communications devices, scheduling information for the one or more wireless communications devices, suggested mappings between the one or more wireless communications devices and the one or more access points, or any combination thereof.
Clause 103. The non-transitory computer-readable medium of clause 102, wherein the positioning session for each wireless communications device in the at least one group of wireless communications devices is scheduled based on information in the allocation report.
Clause 104. The non-transitory computer-readable medium of any of clauses 85 to 103, further comprising computer-executable instructions that, when executed by the access point controller, cause the access point controller to: receive a position estimation request from at least one wireless communications device of the at least one group of wireless communications devices, the position estimation request including positioning measurements obtained by the at least one wireless communications device; and transmit a position estimation response to the at least one wireless communications device, the position estimation response including an estimated position of the at least one wireless communications device.
Clause 105. A non-transitory computer-readable medium storing computer-executable instructions that, when executed by a server, cause the server to: receive a first configuration response from an access point controller, the first configuration response including a first set of parameters related to positioning one or more wireless communications devices using one or more access points; receive a second configuration response from a location server, the second configuration response including a second set of parameters related to positioning the one or more wireless communications devices using one or more transmission-reception points (TRPs); transmit an allocation report to the access point controller, the allocation report providing assistance information for scheduling a first set of positioning sessions for the one or more wireless communications devices with the one or more access points; and transmit session scheduling information to the one or more wireless communications devices, the session scheduling information configuring the one or more wireless communications devices for a second set of positioning sessions with the one or more TRPs.
Clause 106. The non-transitory computer-readable medium of clause 105, wherein the first set of parameters comprises: positioning capability information for the one or more wireless communications devices, positioning capability information for the one or more access points, current positions of the one or more wireless communications devices, current positions of the one or more access points, one or more sets of parameters related to positioning capabilities of the one or more wireless communications devices, the priorities assigned to the one or more wireless communications devices, one or more positioning measurements obtained by the one or more wireless communications devices, or any combination thereof.
Clause 107. The non-transitory computer-readable medium of clause 106, wherein the one or more positioning measurements comprise: one or more round-trip-time (RTT) measurements obtained by the one or more wireless communications devices, one or more angle-of-arrival (AoA) measurements obtained by the one or more wireless communications devices, one or more angle-of-departure (AoD) measurements obtained by the one or more wireless communications devices, one or more time-difference-of-arrival (TDOA) measurements obtained by the one or more wireless communications devices, one or more round-trip-phase (RTP) measurements obtained by the one or more wireless communications devices, or any combination thereof.
Clause 108. The non-transitory computer-readable medium of any of clauses 105 to 107, wherein the second set of parameters comprises: positioning reference signal (PRS) configurations of the one or more TRPs, locations of the one or more TRPs, a base station almanac (BSA) for the one or more TRPS, or any combination thereof.
Clause 109. The non-transitory computer-readable medium of any of clauses 105 to 108, wherein the allocation report includes: a grouping strategy for the one or more wireless communications devices, scheduling information for the one or more wireless communications devices, suggested mappings between the one or more wireless communications devices and the one or more access points, or any combination thereof.
Clause 110. The non-transitory computer-readable medium of any of clauses 105 to 109, wherein the session scheduling information comprises: positioning reference signal (PRS) configurations of the one or more TRPs, locations of the one or more TRPs, a base station almanac (BSA) for the one or more TRPS, or any combination thereof.
Clause 111. The non-transitory computer-readable medium of any of clauses 105 to 110, further comprising computer-executable instructions that, when executed by the server, cause the server to: transmit a first configuration request to the access point controller, wherein the first configuration request requests the first set of parameters, and wherein the first configuration response is received in response to the first configuration request; and transmit a second configuration request to the location server, wherein the second configuration request requests the second set of parameters, and wherein the second configuration response is received in response to the second configuration request.
Clause 112. The non-transitory computer-readable medium of any of clauses 105 to 111, further comprising computer-executable instructions that, when executed by the server, cause the server to: receive a position estimation request from at least one wireless communications device of the one or more wireless communications devices, the position estimation request including positioning measurements of the one or more access points, the one or more TRPs, or both obtained by the at least one wireless communications device; and transmit a position estimation response to the at least one wireless communications device, the position estimation response including an estimated position of the at least one wireless communications device determined based on the positioning measurements of the one or more access points, the one or more TRPs, or both obtained by the at least one wireless communications device.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method of wireless positioning performed by an access point controller, comprising:
receiving, from one or more wireless communications devices, one or more sets of parameters related to positioning capabilities of the one or more wireless communications devices; assigning priorities to the one or more wireless communications devices based on the one or more sets of parameters;
identifying at least one group of wireless communications devices of the one or more wireless communications devices that is associated with at least one common access point of one or more access points in communication with the access point controller; and
scheduling a positioning session for each wireless communications device in the at least one group of wireless communications devices with the at least one common access point.

2. The method of claim 1, wherein, for each wireless communications device of the one or more wireless communications devices, the corresponding set of parameters of the one or more sets of parameters comprises:
an importance of the wireless communications device,
mobility information of the wireless communications device,
a power consumption status of the wireless communications device, a desired latency of the positioning session,
a desired accuracy of the positioning session,
a list of access points with which the wireless communications device is interested in performing the positioning session, or
any combination thereof.

3. The method of claim 1, wherein scheduling the positioning session for each wireless communications device in the at least one group of wireless communications devices is based on frequency-planning to enable multiple wireless communications devices in the at least one group of wireless communications devices to perform positioning measurements on the same channel simultaneously.

4. The method of claim 1, wherein scheduling the positioning session for each wireless communications device in the at least one group of wireless communications devices comprises instructing the at least one common access point to adjust a transmit power of the at least one common access point to minimize interference and permit frequency-multiplexing.

5. The method of claim 1, wherein the at least one group of wireless communications devices is identified based on:
coarse locations of wireless communications devices in the at least one group of wireless communications devices,
a list of access points with which wireless communications devices in the at least one group of wireless communications devices are interested in performing positioning, or
any combination thereof.

6. The method of claim 1, wherein scheduling the positioning session for each wireless communications device in the at least one group of wireless communications devices comprises scheduling positioning sessions for higher priority wireless communications devices of the at least one group of wireless communications devices more frequently that positioning sessions for lower priority wireless communications devices of the at least one group of wireless communications devices.

7. The method of claim 1, further comprising:
transmitting a request to each of the one or more wireless communications devices for the one or more sets of parameters.

8. The method of claim 1, wherein the positioning session for each wireless communications device in the at least one group of wireless communications devices comprises a unicast positioning session.

9. The method of claim 1, wherein the positioning session for each wireless communications device in the at least one group of wireless communications devices comprises a multi-user positioning session.

10. The method of claim 9, wherein the at least one group of wireless communications devices comprises one or more sub-groups of wireless communications devices of the at least one group of wireless communications devices.

11. The method of claim 10, wherein the one or more sub-groups of wireless communications devices are selected based on spatial multiplexing capabilities of wireless communications devices in the one or more sub-groups of wireless communications devices.

12. The method of claim 10, wherein scheduling the positioning session for each wireless communications device in the at least one group of wireless communications devices comprises scheduling a multi-user positioning session for each of the one or more sub-groups of wireless communications devices.

13. The method of claim 10, wherein scheduling the positioning session for each wireless communications device in the at least one group of wireless communications devices comprises scheduling unicast positioning sessions for remaining wireless communications devices in the at least one group of wireless communications devices.

14. The method of claim 9, wherein the multi-user positioning session comprises a multi-user multiple-input multiple-output (MU-MIMO) ranging session.

15. The method of claim 1, further comprising:
transmitting a configuration response to a server, the configuration response including a second set of parameters, the second set of parameters comprising:
positioning capability information for the one or more wireless communications devices,
positioning capability information for the one or more access points, current positions of the one or more wireless communications devices,
current positions of the one or more access points,
the one or more sets of parameters,
the priorities assigned to the one or more wireless communications devices,
one or more positioning measurements obtained by the one or more wireless communications devices, or
any combination thereof.

16. The method of claim 15, wherein the one or more positioning measurements comprise:
one or more round-trip-time (RTT) measurements obtained by the one or more wireless communications devices,
one or more angle-of-arrival (AA) measurements obtained by the one or more wireless communications devices,
one or more angle-of-departure (AoD) measurements obtained by the one or more wireless communications devices,
one or more time-difference-of-arrival (TDOA) measurements obtained by the one or more wireless communications devices,
one or more round-trip-phase (RTP) measurements obtained by the one or more wireless communications devices, or
any combination thereof.

17. The method of claim 15, further comprising:
receiving a configuration request from the server, wherein the configuration request requests the second set of parameters, and wherein the configuration response is transmitted in response to the configuration request.

18. The method of claim 15, further comprising:
receiving an allocation report from the server, the allocation report including:
a grouping strategy for the one or more wireless communications devices,
scheduling information for the one or more wireless communications devices,
suggested mappings between the one or more wireless communications devices and the one or more access points, or
any combination thereof.

19. The method of claim 18, wherein scheduling the positioning session for each wireless communications device in the at least one group of wireless communications devices is based on information in the allocation report.

20-28. (canceled)

29. An access point controller, comprising:
a memory;
at least one transceiver; and
at least one processor communicatively coupled to the memory and the at least one transceiver, the at least one processor configured to:
receive, via the at least one transceiver, from one or more wireless communications devices, one or more sets of parameters related to positioning capabilities of the one or more wireless communications devices;
assign priorities to the one or more wireless communications devices based on the one or more sets of parameters;
identify at least one group of wireless communications devices of the one or more wireless communications devices that is associated with at least one common access point of one or more access points in communication with the access point controller; and
schedule a positioning session for each wireless communications device in the at least one group of wireless communications devices with the at least one common access point.

30. (canceled)
